(19) United States
(12) Patent Application Publication
(10) Pub. No.: US 2005/0233845 A1
(43) Pub. Date: Oct. 20, 2005

(54) Device having a unit for determining a clamping pressure of a wrap belt

(76) Inventors: Andreas Foll, Backnang (DE); Michael Spruth, Aidlingen (DE)

Correspondence Address: WILLIAM COLLARD;COLLARD & ROE, P.C., 1077 NORTHERN BOULEVARD, ROSLYN, NY, 11576, US

(21) Appl. No.: 11/105,298

(22) Filed: Apr. 13, 2005

(30) Foreign Application Priority Data
Apr. 14, 2004 (DE) 10 2004 017 991.3

(51) Int. Cl. F16H 59/00

(52) U.S. Cl. 474/28

(57) ABSTRACT

A device has a unit for determining a clamping pressure of a wrap belt in a stepless wrap gear mechanism. The unit is provided for processing at least one sensor signal, which contains a first characteristic variable for the clamping pressure. The unit is provided for the purpose of processing at least a second characteristic variable for checking the plausibility of the sensor signal.

### CROSS REFERENCE TO RELATED APPLICATIONS

Applicant claims priority under 35 U.S.C. §119 of German Application No. 10 2004 017 991.3 filed Apr. 14, 2004.

### BACKGROUND OF THE INVENTION

1. Field of the Invention

The present invention relates to a device having a unit for determining a clamping pressure of a wrap belt in a stepless wrap gear mechanism, wherein the unit is provided for processing at least one sensor signal which contains a first characteristic variable for the clamping pressure.

2. The Prior Art

A device having a unit for determining and regulating a clamping pressure of a wrap belt of a stepless wrap gear mechanism is known from DE 195 22 674 A1. The unit is intended to process a sensor signal generated by a pressure sensor, which signal is suitable as a characteristic variable for the clamping pressure.

### SUMMARY OF THE INVENTION

The invention aims at making available a device by means of which a particularly reliable determination of the clamping pressure can be achieved. In addition, it is an object of the invention to provide a device by means of which the plausibility errors of the sensor signal, which can be attributable to a malfunction of a sensor, can be advantageously recognized.

The invention proceeds from a device having a unit for determining a clamping pressure of a wrap belt in a stepless wrap gear mechanism. The unit is provided for processing at least one sensor signal, which contains a first characteristic variable for the clamping pressure.

According to one aspect of the invention, the unit is provided for the purpose of processing at least a second characteristic variable for checking the plausibility of the sensor signal. It can advantageously be achieved that a plausibility error of the sensor signal becomes apparent from the second characteristic variable, so that a particularly reliable determination of the clamping pressure can be achieved. In this connection, the unit can generate a correction signal for automatic correction of an error that has been recognized, if a plausibility error is recognized, and/or it can generate a warning signal to warn a driver, and/or it can switch into an emergency mode.

In this connection, “provided” should also be understood to mean “designed” and “equipped.” The second characteristic variable can generate a redundancy and check the plausibility of the sensor signals by means of a comparison of the first and the second characteristic variable. The second characteristic variable can also represent a characteristic variable that is at least partially independent of the first characteristic variable, thereby making it possible to achieve an independent check of the plausibility of the first characteristic variable.

Furthermore, in accordance with another aspect, the sensor signal is at least dependent on a signal of a pressure sensor for detecting a pressure that generates the clamping pressure. In this way, an advantageously direct determination of the clamping pressure can be achieved, and error sources in longer signal chains can be avoided.

If the unit is provided to trigger a switching signal for activating an emergency mode when a plausibility error is recognized, damage to the wrap gear mechanism resulting from an incorrectly determined clamping pressure can be advantageously avoided. In this connection, the emergency mode can either relate to the entire motor vehicle, in that a torque that can be transferred by way of the wrap gear mechanism is restricted, for example, or only to an activation of the wrap gear mechanism, in that a safety clamping pressure that is not optimal with regard to a friction loss at the wrap gear mechanism is selected, for example.

If the unit is provided for processing a characteristic variable for an activity of a pump for hydraulic generation of the clamping pressure, an independent check of the plausibility of the sensor signal can be achieved. The characteristic variable for the pump activity may be determined by means of a pump speed of rotation, an energy consumption of the pump, or another characteristic variable that appears practical to a person skilled in the art. If the sensor signal indicates a high clamping pressure at low pump activity, or vice versa, then there is a plausibility error that can be recognized by the unit.

A particular gain in reliability and convenience can be achieved if the unit is provided to trigger a warning signal to an operator, i.e. driver upon recognition of a plausibility error. This warning signal can be structured to be acoustical or optical, or can be made up of an error message to a maintenance technician, for example by way of an error memory.

If the unit is provided to equalize at least one time delay between the first characteristic variable and the second characteristic variable, incorrect recognition of an apparent plausibility error by the unit can be avoided. Such apparent plausibility error may be attributable to a deviation between the information from the first characteristic variable and the second characteristic variable, caused by the time delay.

In addition, in a further aspect, a method is provided for determining the clamping pressure of a wrap belt in a stepless wrap gear mechanism, which is dependent on at least one characteristic variable for the clamping pressure.

In accordance with this aspect, at least a second characteristic variable is used to check the plausibility of the first characteristic variable. In this way, the result can be achieved that a particularly reliable determination of the clamping pressure can be achieved, and that plausibility errors of the sensor signal can be advantageously detected.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

The claims, the figures, and the description contain several characteristics in combination. A person skilled in the art will also consider these characteristics individually, and will combine them into practical further combinations.

In the drawings:

FIG. 1 shows a device having a wrap gear mechanism and having a unit for determining a clamping pressure of a wrap belt of the wrap gear mechanism,

FIG. 2 is a flow chart for recognition of a first plausibility error by the unit, and

FIG. 3 is a flow chart for recognition of a second plausibility error by the unit.

### DETAILED DESCRIPTION OF PREFERRED EMBODIMENTS

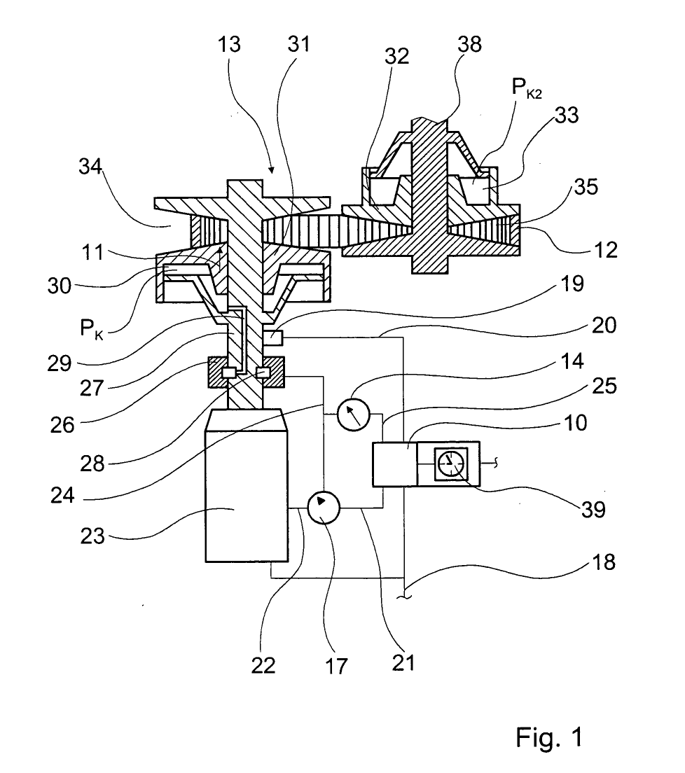

Referring now to the drawings, FIG. 1 shows a device having a unit 10 that is configured as a computer unit having several control outputs and regulation inputs. Unit 10 is connected via a communication line 18 with a controller area network (CAN) bus of a motor vehicle that includes the device. By way of this bus, the unit can query all variables detected in the motor vehicle. In particular, unit 10 can query, via a connection 20, a characteristic variable n that is detected by a speed of rotation sensor 19 and determined by the motor speed of rotation. In this connection, the characteristic variable n is, at the same time, an input speed of rotation of a wrap gear mechanism 13. Furthermore, unit 10 is connected, by way of a control line 21, with a pump 17 that is directly driven by a motor 23, by way of a shaft 22. A pressure sensor 14 detects a pressure generated by the pump, in a pressure line 24, whereby the pressure determined by the sensor is detected by pressure sensor 14 as a characteristic variable P_{S} for a clamping pressure 11, by way of a sensor line 25. The pressure in pressure line 24 propagates itself by means of a hydraulic medium in the pressure line 24, up to a cuff 26 around an input shaft 27. By means of a bore in cuff 26, the pressure propagates itself into a circumferential groove 28 and from there through an axial interior bore 29 in input shaft 27 into a pressure chamber 30 of the wrap gear mechanism, in order to generate a pressure P_{K} there.

A wall surface that delimits the pressure chamber 30 in the direction of a wrap belt 12 is formed by means of a surface, facing away from wrap belt 12, of a conical body 31 movably mounted, in the axial direction, on input shaft 27. The surface of body 31, facing wrap belt 12, is provided to support the body and forms a segment of a conical surface whose axis coincides with an axis of input shaft 27. A second surface, forming a segment of a conical surface, for supporting wrap belt 12 at an opposite edge, is rigidly connected with input shaft 27, whereby the two surfaces form an intermediate space 34 to accommodate wrap belt 12, which widens in the radial direction about input shaft 27.

An output shaft 38 of wrap gear mechanism 13 has an arrangement analogous to the arrangement described above, having a second conical body 32, an intermediate space 35, and a second pressure chamber 33, to which a control pressure P_{K2} can be applied by unit 10 by way of a pump and pressure lines not shown here. If the pressure P_{K} is increased and, at the same time, the control pressure P_{K2} is reduced, intermediate space 34 becomes narrower, and intermediate space 35 becomes wider, which results in a change in a translation of wrap gear mechanism 13.

In order to prevent slipping of wrap belt 12 on the surfaces that delimit intermediate spaces 34, 35, wrap belt 12 is constantly under tension and exerts a force on conical bodies 31, 32 that drives the conical bodies 31, 32 in the direction of pressure chambers 33, 30, in each instance. The counter-force of this force is determined by clamping pressure 11, which is generated by the pressure P_{K} and the control pressure P_{K2}, respectively. Unit 10 can increase clamping pressure 11 by way of an increase in the pressure P_{K}, which can be triggered by way of control line 21, while the control pressure P_{K2} remains the same. In this way, the pressure P_{K} is directly determined by the pressure detected by pressure sensor 14, which pressure can be detected and processed by unit 10 by way of sensor line 25, as a characteristic variable P_{S}. In this connection, the pressure generated by pump 17 is essentially determined by the motor speed of rotation, and can merely be corrected by way of control line 25.

A program that includes functions for recognizing plausibility errors of the sensor signal of pressure sensor 14, i.e. of the characteristic variable P_{S} formed by this sensor signal, is implemented in unit 10.

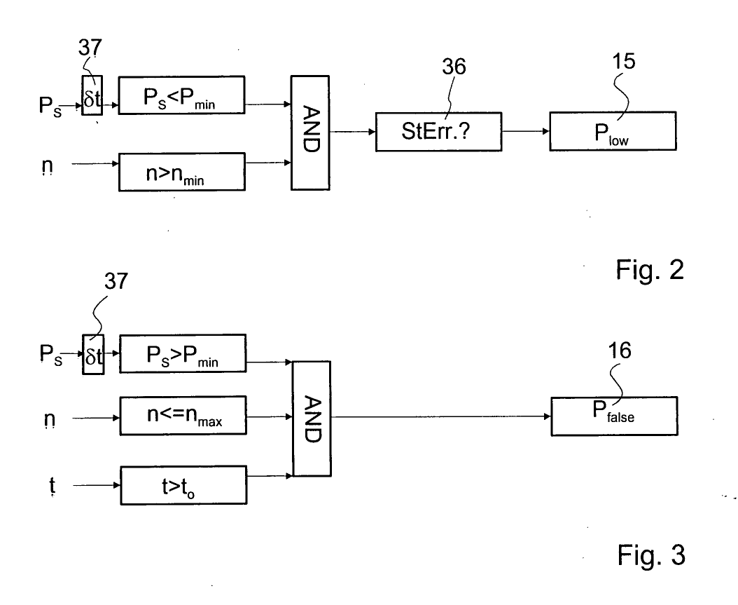

FIG. 2 shows a first function for recognizing a first plausibility error. The input variables are the characteristic variables P_{S} and n. Since the characteristic variable P_{S} follows the characteristic variable n, which is dependent on the pump speed of rotation, with a time delay δt of several milliseconds, if the device is functioning properly, the characteristic variable n is passed through a delay filter 37 that can be selected by a time measurement unit 39, in order to compensate the time delay δt. If the characteristic variable P_{S} is less than a value Pₘᵢₙ, and, at the same time, the characteristic variable n is greater than a value nₘᵢₙ, unit 10 recognizes that there is a plausibility error of the sensor signal. This error is recognized because pump 17 works and produces a pressure that is greater than the pressure determined by pressure sensor 14, at a speed of rotation that is greater than the value nₘᵢₙ. In a step 36, a check takes place to determine whether a global, standard error exists, which could be responsible for this contradiction. If no global, standard error exists, unit 10 triggers a switching signal 15 to switch over into an emergency mode, and generates a warning signal P_{low} on the display of the motor vehicle. A warning message then appears on the display, which informs the driver of an error in a hydraulic plate or in pressure sensor 14.

Unit 10 detects the value of a variable t, which indicates how long the motor 23 is shut off, from the CAN bus (FIG. 3). If variable t has a value greater than a value t₀, the pump 17 is inactive for a corresponding period of time, and a pressure in the pressure line 24 should have dropped to a value close to zero. If the characteristic variable P_{S} nevertheless has a value greater than the value Pₘᵢₙ, unit 10 recognizes a plausibility error of the sensor signal of pressure sensor 14. To check the plausibility error, the function simultaneously demands, with the two aforementioned conditions, that the characteristic variable n must be less than a maximal value nₘₐₓ. If all conditions are met, unit 10 confirms a malfunction of pressure sensor 14. Unit 10 also generates a switching signal 16 for switching into the emergency mode, and for generating a warning signal P_{f}, which informs the driver of the malfunction of pressure sensor 14.

Although only a few embodiments of the present invention have been shown and described, it is to be understood that many changes and modifications may be made thereunto without departing from the spirit and scope of the invention as defined in the appended claims.

1. A device comprising a unit for determining a clamping pressure of a wrap belt in a stepless wrap gear mechanism, said unit adapted for processing at least one sensor signal comprising a first characteristic variable for the clamping pressure and at least a second characteristic variable for checking plausibility of said at least one sensor signal.

2. The device according to claim 1, wherein said at least one sensor signal is at least dependent on a signal of a pressure sensor for detecting a pressure that generates the clamping pressure.

3. The device according to claim 1, wherein said unit is adapted to trigger a switching signal for activating an emergency mode when a plausibility error is recognized.

4. The device according to claim 1, wherein said unit is adapted for processing the second characteristic variable for an activity of a pump for hydraulic generation of the clamping pressure.

5. The device according to claim 1, wherein said unit is adapted to trigger a warning signal to an operator upon recognition of a plausibility error.

6. The device according to claim 1, wherein said unit is adapted to equalize at least one time delay between the first characteristic variable and the second characteristic variable.

7. A method for determining a clamping pressure of a wrap belt in a stepless wrap gear mechanism as a function of at least one characteristic variable for the clamping pressure comprising the steps of:
(a) processing at least one sensor signal comprising a first characteristic variable for the clamping pressure; and
(b) using at least a second characteristic variable for checking plausibility of the first characteristic variable.
